(19) United States
(12) Patent Application Publication
(10) Pub. No.: US 2026/0273980 A1
(43) Pub. Date: Sep. 17, 2026

(54) TRANSFER DEVICE AND TRANSFER METHOD

(71) Applicant: SEIKO EPSON CORPORATION, Tokyo (JP)

(72) Inventor: Yohei SHIBATA, SHIOJIRI-SHI (JP)

(21) Appl. No.: 19/560,236

(22) Filed: Mar. 9, 2026

(30) Foreign Application Priority Data
Mar. 12, 2025 (JP) 2025-039660

(51) Int. Cl. B41M 5/035

(52) U.S. Cl. CPC B41M 5/0358

(57) ABSTRACT

A transfer device includes: a first roll body around which a first transfer sheet, on which a first image is formed, is wound; a second roll body around which a second transfer sheet, on which a second image is formed, is wound; a third roll body around which a fabric sheet for transferring the images to both of the surfaces is wound; a transport unit configured to transport, in a transport direction, a three-layer sheet in a state where the fabric sheet is sandwiched between the first transfer sheet and the second transfer sheet, and cause the three-layer sheet to pass through a transfer region; a first heating unit configured to heat the three-layer sheet from the side of the first transfer sheet in the transfer region; and a second heating unit configured to heat the three-layer sheet from the side of the second transfer sheet in the transfer region.

The present application is based on, and claims priority from JP Application Serial Number 2025-039660, filed Mar. 12, 2025, the disclosure of which is hereby incorporated by reference herein in its entirety.

### BACKGROUND

### 1. Technical Field

The present disclosure relates to a transfer device and a transfer method.

### 2. Related Art

Examples of the related art of the device of this type include a device disclosed in JP-A-10-237775. JP-A-10-237775 discloses a transfer method in which a fabric is sandwiched between a first transfer sheet and a second transfer sheet and is heated to transfer images on both the transfer sheets to both of the surfaces of the fabric.

JP-A-10-237775 is an example of the related art.

In JP-A-10-237775, a thermal cylinder for heating from the side of the second transfer sheet is described as a heating unit for heating a transfer region. However, heating from the side of the first transfer sheet is not considered. Therefore, transfer energy applied by the heating from the side of the second transfer sheet is larger than transfer energy applied to the first transfer sheet. A difference in the transfer energy affects a color development state of each image transferred on both of the surfaces. That is, there is a possibility that a color difference occurs between the images transferred to both of the surfaces. In this respect, there is room for improvement.

### SUMMARY

A transfer device according to an aspect of the disclosure includes: a first roll body around which a first transfer sheet, on which a first image is formed with sublimable ink, is wound; a second roll body around which a second transfer sheet, on which a second image is formed with sublimable ink, is wound; a third roll body around which a fabric sheet for transferring the first image to a first surface and transferring the second image to a second surface is wound; a transport unit configured to transport, in a transport direction, a three-layer sheet in a state where the fabric sheet is sandwiched between the first transfer sheet and the second transfer sheet, and cause the three-layer sheet to pass through a transfer region; a first heating unit configured to heat the three-layer sheet from the side of the first transfer sheet in the transfer region; and a second heating unit configured to heat the three-layer sheet from the side of the second transfer sheet in the transfer region.

In a transfer method of a transfer device according to an aspect of the disclosure, the transfer device includes: a first roll body around which a first transfer sheet, on which a first image is formed with sublimable ink, is wound; a second roll body around which a second transfer sheet, on which a second image is formed with sublimable ink, is wound; a third roll body around which a fabric sheet for transferring the first image to a first surface and transferring the second image to a second surface is wound; a transport unit configured to transport, in a transport direction, a three-layer sheet in a state where the fabric sheet is sandwiched between the first transfer sheet and the second transfer sheet, and cause the three-layer sheet to pass through a transfer region; and a heating unit configured to heat the three-layer sheet. The transfer method includes: heating the transported three-layer sheet from the side of the first transfer sheet; and heating and transferring the transported three-layer sheet from the side of the second transfer sheet.

### BRIEF DESCRIPTION OF THE DRAWINGS

FIG. 1 is a schematic side view of a transfer device according to a first embodiment.

FIG. 2 is a main part enlarged view of FIG. 1.

FIG. 3 is a schematic side view of a transfer device according to a second embodiment.

FIG. 4 is a schematic side view of a transfer device according to a third embodiment and a fourth embodiment.

FIG. 5 is a schematic side view of a main part of a transfer device according to a fifth embodiment.

### DESCRIPTION OF EMBODIMENTS

First, an overview of the disclosure will be described.

In order to solve the above problems, a transfer device according to a first aspect of the disclosure includes: a first roll body around which a first transfer sheet, on which a first image is formed with sublimable ink, is wound; a second roll body around which a second transfer sheet, on which a second image is formed with sublimable ink, is wound; a third roll body around which a fabric sheet for transferring the first image to a first surface and transferring the second image to a second surface is wound; a transport unit configured to transport, in a transport direction, a three-layer sheet in a state where the fabric sheet is sandwiched between the first transfer sheet and the second transfer sheet, and cause the three-layer sheet to pass through a transfer region; a first heating unit configured to heat the three-layer sheet from the side of the first transfer sheet in the transfer region; and a second heating unit configured to heat the three-layer sheet from the side of the second transfer sheet in the transfer region.

According to this aspect, the first heating unit that heats the three-layer sheet as a heating target from the side of the first transfer sheet in the transfer region, and the second heating unit that heats the three-layer sheet as a heating target from the side of the second transfer sheet in the transfer region are provided. Accordingly, transfer energy applied by heating the transfer region from the side of the second transfer sheet can be adjusted to be equal to transfer energy applied to the transfer region from the side of the first transfer sheet. Therefore, it is possible to prevent color development states of the images transferred to both of the surfaces of the fabric sheet from being different from each other due to a difference in the transfer energy, that is, to prevent a color difference from occurring between both of the surfaces.

The transfer device according to a second aspect of the disclosure is an aspect subordinate to the first aspect, and further includes: a pressure applying unit configured to apply pressure to the three-layer sheet, which is positioned in a region heated by the first heating unit and the second heating unit, in a direction in which the sheets are in close contact with each other.

According to this aspect, the transfer is performed in a state where the pressure applying unit applies the pressure to the three-layer sheet in the direction in which the sheets are in close contact with each other. Accordingly, it is possible to implement strong transfer.

The transfer device according to a third aspect of the disclosure is an aspect subordinate to the second aspect, in which the first heating unit has an outer surface of a cylindrical body and heats the three-layer sheet in surface contact with the outer surface while being transported, and the second heating unit heats the three-layer sheet at a side opposite to the first heating unit.

According to this aspect, the first heating unit heats the three-layer sheet in surface contact with the outer surface of the cylindrical body. On the other hand, the second heating unit heats the three-layer sheet at a side opposite to the first heating unit. That is, in the three-layer sheet, a substantially U-shaped curved surface portion wound around and in surface contact with the outer surface of the cylindrical body forming the first heating unit is heated from the inside. Further, in the three-layer sheet, the curved surface portion is heated from the outside by the second heating unit.

Therefore, in the three-layer sheet, the curved surface portion, which is the same region, is heated from the inside by the first heating unit and is also heated from the outside by the second heating unit, and thus it is easy to equally apply the transfer energy to both of the surfaces.

The transfer device according to a fourth aspect of the disclosure is an aspect subordinate to the third aspect, in which the second heating unit heats the three-layer sheet by radiant heat in a non-contact manner.

According to this aspect, the second heating unit heats the three-layer sheet by radiant heat in a non-contact manner. Accordingly, the second heating unit can be provided with a simple structure.

The transfer device according to a fifth aspect of the disclosure is an aspect subordinate to the third aspect, in which the second heating unit includes a plurality of heat rollers that heat the three-layer sheet while rotating in contact with the three-layer sheet.

According to this aspect, the second heating unit uses the plurality of heat rollers that heat the three-layer sheet while rotating in contact with the three-layer sheet. Accordingly, the second heating unit can be provided with a simple structure. Further, by providing the heat rollers in a state of being pressed against the three-layer sheet, the heat rollers can serve not only as a heating function but also as a part or all of the pressure applying function of the pressure applying unit.

The transfer device according to a sixth aspect of the disclosure is an aspect subordinate to the second aspect, in which the first heating unit has an outer surface of a cylindrical body and heats the three-layer sheet in surface contact with the outer surface while being transported, the second heating unit heats the three-layer sheet at a position different from the first heating unit, and the pressure applying unit for the different position of the three-layer sheet is a pressure roller that applies the pressure to the three-layer sheet from a side opposite to the second heating unit.

According to this aspect, the second heating unit heats the three-layer sheet at a position different from the first heating unit. The pressure applying unit for the different position of the three-layer sheet is the pressure roller that applies the pressure to the three-layer sheet from the side opposite to the second heating unit. Accordingly, the degree of freedom of the arrangement of the second heating unit is increased, and the design can be facilitated.

The transfer device according to a seventh aspect of the disclosure is an aspect subordinate to the sixth aspect, in which the second heating unit heats the three-layer sheet at a side opposite to the first heating unit in addition to heating the three-layer sheet at the position different from the first heating unit.

According to this aspect, the second heating unit heats the three-layer sheet at a side opposite to the first heating unit in addition to heating the three-layer sheet at the position different from the first heating unit. That is, both configurations of the third aspect and the sixth aspect are provided. Accordingly, the effects of both the third aspect and the sixth aspect can be obtained.

The transfer device according to an eighth aspect of the disclosure is an aspect subordinate to the second aspect, in which the first heating unit has a first flat surface that is in contact with the three-layer sheet while moving in the transport direction, the second heating unit has a second flat surface that is in contact with the three-layer sheet while moving in the transport direction, and the first flat surface and the second flat surface also serve as the pressure applying unit.

According to this aspect, the first heating unit has the first flat surface that is in contact with the three-layer sheet while moving. The second heating unit has the second flat surface that is in contact with the three-layer sheet while moving. The first flat surface and the second flat surface serve as the pressure applying unit. Accordingly, the transfer to both of the surfaces of the fabric sheet can be performed while the three-layer sheet is transported in a flat state without being curved.

When the first flat surface of the first heating unit and the second flat surface of the second heating unit are pressed against each other, the structure of the pressure applying unit can be implemented, and thus the structure can be simplified.

The transfer device according to a ninth aspect of the disclosure is an aspect subordinate to the second aspect, in which at least one of the first heating unit and the second heating unit is detachable.

According to this aspect, at least one of the first heating unit and the second heating unit is detachable. Accordingly, it is possible to retrofit the transfer device to an existing transfer device.

The transfer device according to a tenth aspect of the disclosure is the transfer device according to any one of the first aspect to the ninth aspect, and further includes: a control unit, in which the control unit is configured to receive a change in at least one of a heating temperature of the first heating unit and a heating temperature of the second heating unit.

The appropriateness of the transfer energy may vary depending on the type and combination of the first transfer sheet, the second transfer sheet, and the fabric sheet forming the three-layer sheet. The appropriateness of the transfer energy may change depending on a state of an environment such as the temperature or humidity of the place where the transfer device is placed.

According to this aspect, the control unit can receive a change in at least one of the heating temperature of the first heating unit and the heating temperature of the second heating unit. Accordingly, it is possible to adjust a magnitude of the transfer energy by changing the heating temperature, thereby maintaining the transfer energy in an appropriate state.

In a transfer method of the transfer device according to an eleventh aspect of the disclosure, the transfer device includes: a first roll body around which a first transfer sheet, on which a first image is formed with sublimable ink, is wound; a second roll body around which a second transfer sheet, on which a second image is formed with sublimable ink, is wound; a third roll body around which a fabric sheet for transferring the first image to a first surface and transferring the second image to a second surface is wound; a transport unit configured to transport, in a transport direction, a three-layer sheet in a state where the fabric sheet is sandwiched between the first transfer sheet and the second transfer sheet, and cause the three-layer sheet to pass through a transfer region; and a heating unit configured to heat the three-layer sheet. The transfer method includes: heating the transported three-layer sheet from the side of the first transfer sheet; and heating and transferring the transported three-layer sheet from the side of the second transfer sheet.

According to this aspect, the same effects as those of the transfer device according to the first aspect can be obtained.

### EMBODIMENTS

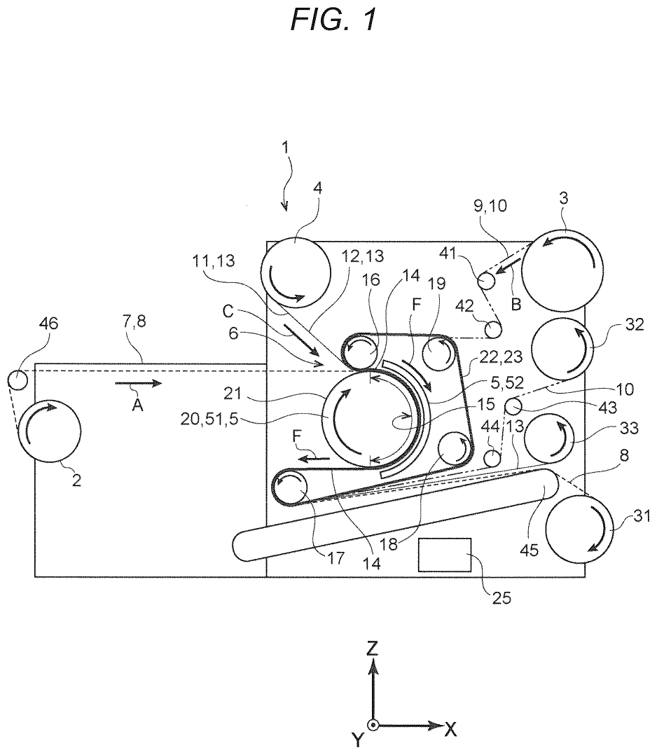

Hereinafter, a transfer device and a transfer method according to an embodiment of the disclosure will be specifically described with reference to FIGS. 1 to 5.

In the description below, three axes orthogonal to one another are respectively defined as an X axis, a Y axis, and a Z axis as illustrated in the drawings. Directions indicated by arrows of the three axes (X, Y, and Z) are positive (+) directions in the respective directions, and opposite directions thereof are negative (−) directions. The Z axis direction is equivalent to a vertical direction, that is, a direction in which the gravity acts, the +Z direction indicates a vertically upward direction and the −Z direction indicates a vertically downward direction. An X axis direction and a Y axis direction are equivalent to a horizontal direction. The +X direction indicates a right direction of the transfer device, and the −X direction indicates a left direction of the transfer device. A +Y direction indicates a front direction of the transfer device and a −Y direction indicates a rear direction of the transfer device.

### First Embodiment

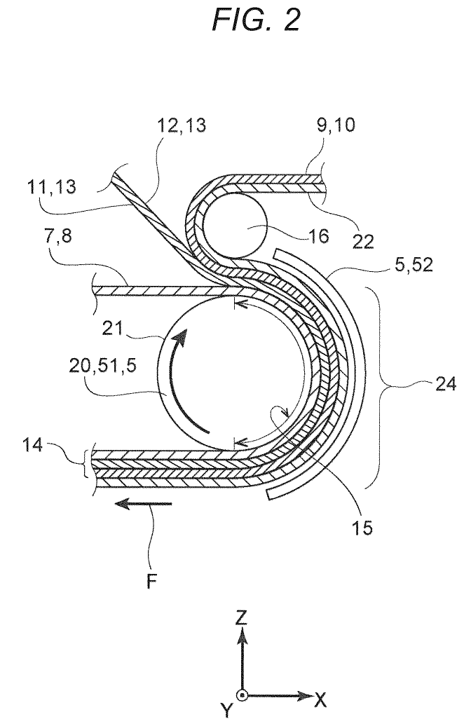

As illustrated in FIGS. 1 and 2, a transfer device 1 according to a first embodiment includes a first roll body 2, a second roll body 3, a third roll body 4, a heating unit 5, and a transport unit 6.

The first roll body 2 is a roll body around which a first transfer sheet 8, on which a first image 7 is formed with sublimable ink, is wound. The first roll body 2 feeds the first transfer sheet 8 in a feeding direction A by rotating a shaft (not illustrated). The second roll body 3 is a roll body around which a second transfer sheet 10, on which a second image 9 is formed with sublimable ink, is wound. The second roll body 3 feeds the second transfer sheet 10 in a feeding direction B by rotating a shaft (not illustrated). The third roll body 4 is a roll body around which a fabric sheet 13 such as fabric for transferring the first image 7 to a first surface 11 and transferring the second image 9 to a second surface 12 is wound. The third roll body 4 feeds the fabric sheet 13 in a feeding direction C by rotating a shaft (not illustrated).

The shafts of the first roll body 2, the second roll body 3, and the third roll body 4 are rotatably driven by rotational power transmitted from a motor (not illustrated).

The first transfer sheet 8, the second transfer sheet 10, and the fabric sheet 13 are formed into a three-layer sheet 14 in a state where the fabric sheet 13 is sandwiched between the first transfer sheet 8 and the second transfer sheet 10 at an upstream position of a transfer region 15 to be described later in a transport direction F of the transport unit 6 to be described later, and pass through the transfer region 15.

The heating unit 5 includes a first heating unit 51 and a second heating unit 52. The first heating unit 51 and the second heating unit 52 can be adjusted to change a heating temperature by a control signal from a control unit 25 described later. The first heating unit 51 heats the three-layer sheet 14 as a heating target from the side of the first transfer sheet 8 in the transfer region 15. In the embodiment, the first heating unit 51 is implemented by a rotating cylindrical body 20. Here, the cylindrical body 20 is a thermal cylinder. The three-layer sheet 14 is heated by surface contact with an outer surface 21 of the cylindrical body 20.

The second heating unit 52 heats the three-layer sheet 14 as a heating target from the side of the second transfer sheet 10 in the transfer region 15. The second heating unit 52 heats the three-layer sheet 14 at a side opposite to the first heating unit 51. In the embodiment, the second heating unit 52 uses an infrared heater and heats the three-layer sheet 14 by radiant heat in a non-contact manner. The second heating unit 52 may use a warm air heater.

In the embodiment, at least one of the first heating unit 51 and the second heating unit 52 is configured to be detachable. Here, the second heating unit 52 is formed as a detachable unit.

The transport unit 6 transports the three-layer sheet 14 in the transport direction F to pass through the transfer region 15.

In the embodiment, the transport unit 6 includes a first transport roller 16, a second transport roller 17, a third transport roller 18, and a fourth transport roller 19. An endless felt belt 22 is wound around the four transport rollers 16, 17, 18, and 19 of the transport unit 6. When the four transport rollers 16, 17, 18, and 19 rotate, the belt 22 circulates and transports the three-layer sheet 14.

The belt 22 is pressing the three-layer sheet 14 against the outer surface 21 of the cylindrical body 20. That is, the belt 22 also serves as a pressure applying unit 23 that applies pressure to the three-layer sheet 14 positioned in the transfer region 15, which is a region heated by the first heating unit 51 and the second heating unit 52, in a direction in which the sheets 8, 13, and 10 are in close contact with each other.

As can be understood from the above description, the transfer region 15 is a region in which the transported three-layer sheet 14 is heated by the heating unit 5, and here, is a region in which the pressure is also applied by the pressure applying unit 23.

The cylindrical body 20 and the belt 22 rotate in synchronization with each other.

As illustrated in FIGS. 1 and 2, the first transfer sheet 8, the second transfer sheet 10, and the fabric sheet 13 are configured such that the sheets 8, 13, and 10 overlap each other to form the three-layer sheet 14 when passing between the cylindrical body 20 and the first transport roller 16. In the three-layer sheet 14, a substantially U-shaped curved surface portion 24 (FIG. 2) wound around and in surface contact with the outer surface 21 of the cylindrical body 20 forming the first heating unit 51 is heated from the inside. Further, in the three-layer sheet 14, the curved surface portion 24 is heated from the outside by the second heating unit 52.

The cylindrical body 20 is rotatably driven by rotational power transmitted from a motor (not illustrated). By this rotation, the cylindrical body 20 acts to transport the three-layer sheet 14 in the transport direction F. That is, the cylindrical body 20 has a function as the transport unit 6 in addition to a function as the heating unit. The four transport rollers 16, 17, 18, and 19 of the transport unit 6 are driven and rotated by rotational power transmitted from a motor (not illustrated). At least one of the transport rollers 16, 17, 18, and 19 may be rotatably driven, and the others may be slave driven and rotated.

The three-layer sheet 14 passes through the transfer region 15, and is further separated after the transport direction F is reversed by the second transport roller 17. The first transfer sheet 8 is wound around a first winding unit 31 in a state where the first image 7 is eliminated. In addition, the second transfer sheet 10 is wound around a second winding unit 32 in a state where the second image 9 is eliminated. The fabric sheet 13 is wound around a third winding unit 33 in a state where the first image 7 and the second image 9 are transferred.

The first winding unit 31, the second winding unit 32, and the third winding unit 33 are rotatably driven by rotational power transmitted from a motor (not illustrated).

In FIG. 1, reference numerals 41, 42, 43, 44, 45, and 46 each denote a guide member that guides feeding of each of the sheets 8, 10, and 13.

The transfer device 1 includes the control unit 25. The control unit 25 receives a change in at least one of the heating temperature of the first heating unit 51 and the heating temperature of the second heating unit 52. When information indicating that the heating temperature is to be changed is input to an operation panel (not illustrated) provided in the transfer device 1, the control unit 25 changes the heating temperature based on the information.

The control unit 25 includes a CPU, a flash ROM, and a RAM. The CPU performs various arithmetic processing according to a program stored in the flash ROM, and controls an operation of the entire transfer device 1 including the adjustment of the heating temperature. The flash ROM, which is an example of a storage unit, is a readable and writable nonvolatile memory. The RAM, which is an example of a storage unit, temporarily stores various types of information.

### Description of Function of First Embodiment: Transfer Method

Next, functions of the first embodiment will be described.

The first transfer sheet 8 is fed from the first roll body 2 toward the transfer region 15. The second transfer sheet 10 is fed from the second roll body 3 toward the transfer region 15. The fabric sheet 13 is fed from the third roll body 4 toward the transfer region 15. The sheets 8, 13, and 10 become the three-layer sheet 14 in which the sheets 8, 13, and 10 are overlapped with each other in surface contact when passing between the first transport roller 16 and the cylindrical body 20, which is the first heating unit 51.

The three-layer sheet 14 is pressed by the pressure applying unit 23 against the cylindrical body 20, which is rotating, when the three-layer sheet 14 is transported through the transfer region 15 by the transport unit 6. When the three-layer sheet 14 is further transported through the transfer region 15, the three-layer sheet 14 is heated from the side of the first transfer sheet 8 by the first heating unit 51 and is heated from the side of the second transfer sheet 10 by the second heating unit 52. That is, the three-layer sheet 14 is transported through the transfer region in a state of being heated from both the first transfer sheet 8 and the second transfer sheet 10, and the transfer is executed.

### Description of Effects of First Embodiment

(1) The embodiment includes the first heating unit 51 that heats the three-layer sheet 14 as a heating target from the side of the first transfer sheet 8 in the transfer region 15, and the second heating unit 52 that heats the three-layer sheet 14 as a heating target from the side of the second transfer sheet 10 in the transfer region 15. Accordingly, the transfer energy applied by heating the transfer region 15 from the side of the second transfer sheet 10 can be adjusted to be equal to the transfer energy applied to the transfer region 15 from the side of the first transfer sheet 8. Therefore, it is possible to prevent color development states of the images 7 and 9 transferred to both of the surfaces 11 and 12 of the fabric sheet 13 from being different from each other due to the difference in the transfer energy, that is, to prevent the color difference from occurring between both of the surfaces 11 and 12.
(2) In the embodiment, the transfer is performed in a state where the pressure applying unit 23 applies the pressure to the three-layer sheet 14 in a direction in which the sheets are in close contact with each other. Accordingly, it is possible to implement strong transfer.
(3) In the embodiment, the first heating unit 51 heats the three-layer sheet 14 in surface contact with the outer surface 21 of the cylindrical body 20. On the other hand, the second heating unit 52 heats the three-layer sheet 14 at a side opposite to the first heating unit 51. That is, in the three-layer sheet 14, the substantially U-shaped curved surface portion 24 wound around and in surface contact with the outer surface 21 of the cylindrical body 20 forming the first heating unit 51 is heated from the inside. Further, in the three-layer sheet 14, the curved surface portion 24 is heated from the outside by the second heating unit 52.

Therefore, in the three-layer sheet 14, the curved surface portion 24, which is the same region, is heated from the inside by the first heating unit 51 and is also heated from the outside by the second heating unit 52, and thus it is easy to equally apply the transfer energy to both of the surfaces 11 and 12.
(4) In the embodiment, the second heating unit 52 heats the three-layer sheet 14 by radiant heat in a non-contact manner. Accordingly, the second heating unit 52 can be provided with a simple structure.
(5) In the embodiment, at least one of the first heating unit 51 and the second heating unit 52 is detachable. Accordingly, it is possible to retrofit the transfer device to an existing transfer device.
(6) The appropriateness of the transfer energy may vary depending on the type and combination of the first transfer sheet 8, the second transfer sheet 10, and the fabric sheet 13 forming the three-layer sheet 14. The appropriateness of the transfer energy may change depending on a state of an environment such as the temperature or humidity of the place where the transfer device 1 is placed.

In the embodiment, the control unit 25 can receive a change in at least one of the heating temperature of the first heating unit 51 and the heating temperature of the second heating unit 52. Accordingly, it is possible to adjust a magnitude of the transfer energy by changing the heating temperature, thereby maintaining the transfer energy in an appropriate state.

### Second Embodiment

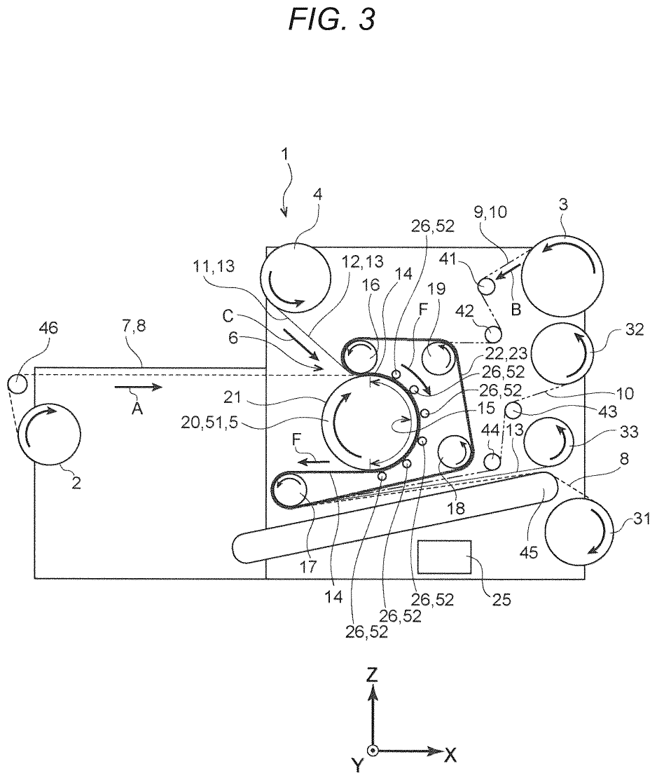

Next, the transfer device 1 according to a second embodiment will be described with reference to FIG. 3. The same portions as the portions in the first embodiment are denoted by the same reference numerals and signs, and the description of configurations of the portions and effects corresponding to the configurations is omitted.

In the embodiment, the second heating unit 52 uses a plurality of heat rollers 26, 26, . . . that heat the three-layer sheet 14 while rotating in contact with the three-layer sheet 14. Here, the heat rollers 26, 26, . . . are provided in a state of being pressed against the outer surface 21 of the cylindrical body 20.

That is, the heat rollers 26, 26, . . . have a function of heating the three-layer sheet 14 and a function of applying the same pressure as the pressure applying unit 23. Specifically, the heat rollers 26, 26, . . . serve to support the pressure of the belt 22 on the three-layer sheet 14.

In the embodiment, the second heating unit 52 includes the plurality of heat rollers 26, 26, . . . that heat the three-layer sheet 14 while rotating in contact with the three-layer sheet 14. Accordingly, the second heating unit 52 can be provided with a simple structure. Further, by providing the heat rollers 26, 26, . . . in a state of being pressed against the three-layer sheet 14, the heat rollers 26, 26, . . . can serve not only as a heating function but also as a part or all of the pressure applying function of the pressure applying unit 23.

### Third Embodiment

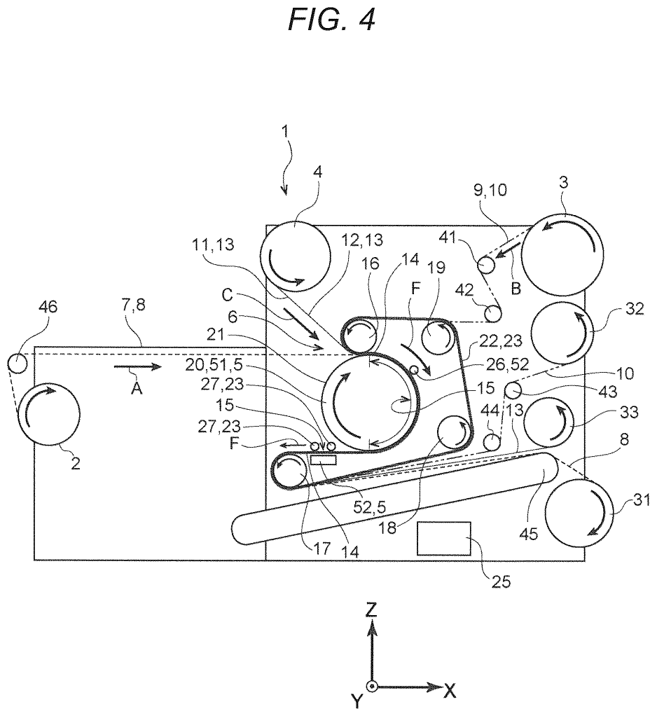

Next, the transfer device 1 according to a third embodiment will be described with reference to FIG. 4. The same portions as the portions in the first embodiment or the second embodiment are denoted by the same reference numerals and signs, and the description of configurations of the portions and effects corresponding to the configurations is omitted.

In the embodiment, similarly to the first embodiment, the first heating unit 51 has the outer surface 21 of the cylindrical body 20 and heats the three-layer sheet 14 that is in surface contact with the outer surface 21 while being transported.

On the other hand, the second heating unit 52 heats the three-layer sheet 14 at a position different from the first heating unit 51. Here, an infrared heater that heats with radiant heat is used as the second heating unit 52, and a warm air heater may be used. Alternatively, the second heating unit 52 may include a plurality of heat rollers that are in contact with and heat the three-layer sheet.

The pressure applying unit 23 for the different position of the three-layer sheet 14 is a pressure roller 27 that applies the pressure to the three-layer sheet 14 from the side opposite to the second heating unit 52.

In the embodiment, the second heating unit 52 heats the three-layer sheet 14 at a position different from the first heating unit 51. The pressure applying unit 23 for the different position of the three-layer sheet 14 is the pressure roller 27 that applies the pressure to the three-layer sheet 14 from the side opposite to the second heating unit 52. Accordingly, the degree of freedom of the arrangement of the second heating unit 52 is increased, and the design can be facilitated.

### Fourth Embodiment

Next, the transfer device 1 according to a fourth embodiment will be described with reference to FIG. 4. The same portions as the portions in the third embodiment are denoted by the same reference numerals and signs, and the description of configurations of the portions and effects corresponding to the configurations is omitted.

In the embodiment, the heat roller 26 is added to the configuration of the third embodiment.

That is, the second heating unit 52 heats the three-layer sheet 14 at a side opposite to the first heating unit 51 in addition to heating the three-layer sheet 14 at a position different from the first heating unit 51 (third embodiment). Here, one heat roller 26 is used as the second heating unit 52 that heats the three-layer sheet 14 at a side opposite to the first heating unit 51.

The plurality of heat rollers 26 may be provided. Alternatively, an infrared heater or a warm air heater may be used instead of the heat roller 26.

In the embodiment, the second heating unit 52 includes the heat roller 26 or the like that heats the three-layer sheet 14 at a side opposite to the first heating unit 51 in addition to heating the three-layer sheet 14 at a position different from the first heating unit 51 (third embodiment). That is, the configurations of both the second embodiment and the third embodiment are provided. Accordingly, the effects of both the second embodiment and the third embodiment can be obtained.

### Fifth Embodiment

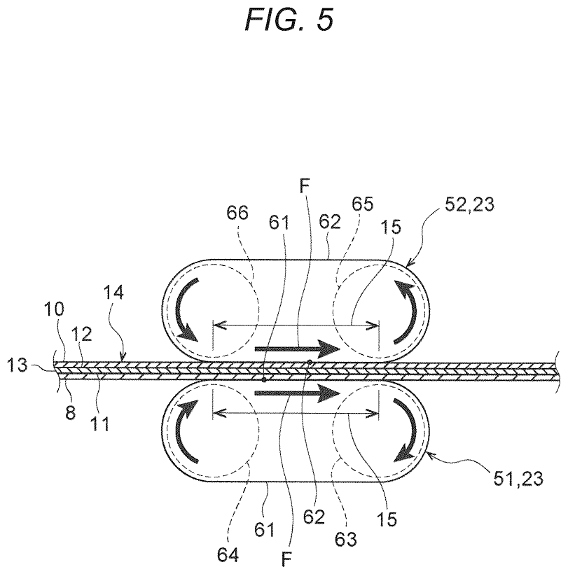

Next, the transfer device 1 according to a fifth embodiment will be described with reference to FIG. 5. The same portions as the portions in the first embodiment are denoted by the same reference numerals and signs, and the description of configurations of the portions and effects corresponding to the configurations is omitted.

The embodiment is configured as follows. The first heating unit 51 has a first flat surface 61 that is in contact with the three-layer sheet 14 from the side of the first transfer sheet 8 while moving in the transport direction F. The second heating unit 52 has a second flat surface 62 that is in contact with the three-layer sheet 14 from the side of the second transfer sheet 10 while moving in the transport direction F.

The first flat surface 61 is made of a heat conductive belt wound around a pair of heat rollers 63 and 64. When the pair of heat rollers 63 and 64 rotate, the heat conductive belt circulates, and a portion facing the three-layer sheet 14 is in contact with the three-layer sheet 14 in a flat posture.

The second flat surface 62 is made of a heat conductive belt wound around a pair of heat rollers 65 and 66. When the pair of heat rollers 65 and 66 rotate, the heat conductive belt circulates, and a portion facing the three-layer sheet 14 is in contact with the three-layer sheet 14 in a flat posture.

In the embodiment, the first flat surface 61 and the second flat surface 62 serve as the pressure applying unit 23. That is, the first flat surface 61 and the second flat surface 62 are pressed against each other by an elastic mechanism (not illustrated) with the three-layer sheet 14 interposed therebetween. Specifically, the first flat surface 61 is pressed against the first transfer sheet 8 via the pair of heat rollers 63 and 64. The second flat surface 62 is pressed against the second transfer sheet 10 via the pair of heat rollers 65 and 66.

In the embodiment, the first heating unit 51 has the first flat surface 61 that is in contact with the three-layer sheet 14 while moving. The second heating unit 52 has the second flat surface 62 that is in contact with the three-layer sheet 14 while moving. Further, the first flat surface 61 and the second flat surface 62 serve as the pressure applying unit 23. Accordingly, the transfer to both of the surfaces of the fabric sheet 13 can be performed while the three-layer sheet 14 is transported in a flat state without being curved.

When the first flat surface 61 of the first heating unit 51 and the second flat surface 62 of the second heating unit 52 are pressed against each other, the structure of the pressure applying unit 23 can be implemented, and thus the structure can be simplified.

### Other Embodiments

The transfer device 1 and the transfer method according to the disclosure basically have the configurations according to the above-described embodiments, but as a matter of course, changes, omissions, or the like of some parts of the configurations can be made without departing from the scope of the disclosure.

What is claimed is:

1. A transfer device comprising:
a first roll body around which a first transfer sheet, on which a first image is formed with sublimable ink, is wound;
a second roll body around which a second transfer sheet, on which a second image is formed with sublimable ink, is wound;
a third roll body around which a fabric sheet for transferring the first image to a first surface and transferring the second image to a second surface is wound;
a transport unit configured to transport, in a transport direction, a three-layer sheet in a state where the fabric sheet is sandwiched between the first transfer sheet and the second transfer sheet, and cause the three-layer sheet to pass through a transfer region;
a first heating unit configured to heat the three-layer sheet from the side of the first transfer sheet in the transfer region; and
a second heating unit configured to heat the three-layer sheet from the side of the second transfer sheet in the transfer region.

2. The transfer device according to claim 1, further comprising:
a pressure applying unit configured to apply pressure to the three-layer sheet, which is positioned in a region heated by the first heating unit and the second heating unit, in a direction in which the sheets are in close contact with each other.

3. The transfer device according to claim 2, wherein
the first heating unit has an outer surface of a cylindrical body and heats the three-layer sheet in surface contact with the outer surface while being transported, and
the second heating unit heats the three-layer sheet at a side opposite to the first heating unit.

4. The transfer device according to claim 3, wherein
the second heating unit heats the three-layer sheet by radiant heat in a non-contact manner.

5. The transfer device according to claim 3, wherein
the second heating unit includes a plurality of heat rollers that heat the three-layer sheet while rotating in contact with the three-layer sheet.

6. The transfer device according to claim 2, wherein
the first heating unit has an outer surface of a cylindrical body and heats the three-layer sheet in surface contact with the outer surface while being transported,
the second heating unit heats the three-layer sheet at a position different from the first heating unit, and
the pressure applying unit for the different position of the three-layer sheet is a pressure roller that applies the pressure to the three-layer sheet from a side opposite to the second heating unit.

7. The transfer device according to claim 6, wherein
the second heating unit heats the three-layer sheet at a side opposite to the first heating unit in addition to heating the three-layer sheet at the position different from the first heating unit.

8. The transfer device according to claim 2, wherein
the first heating unit has a first flat surface that is in contact with the three-layer sheet while moving in the transport direction,
the second heating unit has a second flat surface that is in contact with the three-layer sheet while moving in the transport direction, and
the first flat surface and the second flat surface also serve as the pressure applying unit.

9. The transfer device according to claim 2, wherein
at least one of the first heating unit and the second heating unit is detachable.

10. The transfer device according to claim 1, further comprising:
a control unit, wherein
the control unit is configured to receive a change in at least one of a heating temperature of the first heating unit and a heating temperature of the second heating unit.

11. A transfer method of a transfer device, wherein
the transfer device includes
a first roll body around which a first transfer sheet, on which a first image is formed with sublimable ink, is wound,
a second roll body around which a second transfer sheet, on which a second image is formed with sublimable ink, is wound,
a third roll body around which a fabric sheet for transferring the first image to a first surface and transferring the second image to a second surface is wound,
a transport unit configured to transport, in a transport direction, a three-layer sheet in a state where the fabric sheet is sandwiched between the first transfer sheet and the second transfer sheet, and cause the three-layer sheet to pass through a transfer region, and
a heating unit configured to heat the three-layer sheet, and
the transfer method comprises:
heating the transported three-layer sheet from the side of the first transfer sheet; and
heating and transferring the transported three-layer sheet from the side of the second transfer sheet.
